(19) United States
(12) Patent Application Publication
(10) Pub. No.: US 2025/0333092 A1
(43) Pub. Date: Oct. 30, 2025

(54) Magnet Closure Linen Cart Cover

(71) Applicant: Courtney Pfeil, Messina, TX (US)

(72) Inventor: Courtney Pfeil, Messina, TX (US)

(21) Appl. No.: 18/644,406

(22) Filed: Apr. 24, 2024

(51) Int. Cl. B62B 5/00

(52) U.S. Cl. CPC B62B 5/0013; B62B 2501/06

(57) ABSTRACT

This invention relates to a protective cover assembly primarily designed to enclose a mobile delivery cart of the type used for the distribution of a variety of items, at least some of which should be maintained in at least a partially sterile environment, such as items used in hospitals or like medical facilities. The cover assembly includes magnets along both outside edges of the cover not only weighing the cover down, but also magnetically attracted to magnets located on the cart along the edges facing the cover, instilling a connection of the cover assembly to the mobile delivery cart In addition, glass beads or something heavy can be attached to the bottom edge of the protective cover to weigh the cover down and assist in closing the cover or otherwise attaching the cover to the mobile cart. In this manner any number of items may be periodically removed from the mobile delivery cart while preserving the partially to mostly sterile environment on the mobile delivery cart.

### BACKGROUND OF THE INVENTION

Manually powered or propelled carts, hand trucks, bins, and the like are widely known and used in a variety of both commercial and domestic applications and typically involve the temporary storage and transport of a variety of items from one location to another in the same physical facility. Carts of this type referred to may take a variety of structural designs and configurations depending upon their intended use and/or the items which they are intended to contain. Such structural variations include carts designed to carry open top bins that are primarily designed to contain a plurality of loosely stored items. Examples may include grocery carts and carts used in hotels that carry a number of bins holding soap bar, containers of shampoo, etc. More structurally complex carts however, which include a plurality of shelves, open or closed compartments and/or segregated areas, and are therefore designed to contain a plurality of products or items of the same kind of class.

### SUMMARY OF THE INVENTION

This invention uses magnets sewn into the edges of the mobile delivery cart cover to magnetically stick the cart cover to the edges of the mobile delivery cart. If the mobile delivery cart is not metal such that the magnets sewn into the edges of the mobile delivery cart cover do not magnetically stick to the mobile delivery cart, we will attach magnets or metal pieces to the mobile delivery cart such that the cart cover does magnetically stick to the mobile delivery cart. In this way, the cart cover will automatically close after ingress.

### BRIEF DESCRIPTION OF DRAWINGS

FIG. 1 illustrates a linen cart 13 or some such cart to carry the contents 4, comprising a linen cart cover 1 covering the cart contents 4, and also locations on the face of the cart 13 facing the cart cover 3 where magnets or pieces of metal can be located. Also shown is location 2 where the protective cart cover meets the edge of the mobile delivery cart's outside edge that faces the protective cart cover.

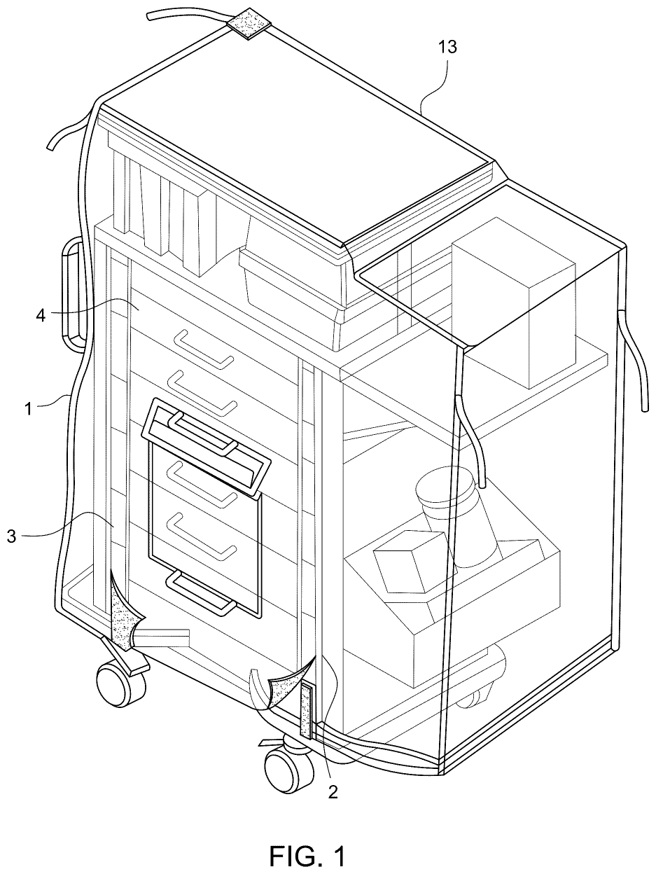

FIG. 2 illustrates a mobile delivery cart depicting those areas on the mobile delivery cart that the mobile delivery cart cover will be attached to the mobile delivery cart where magnets may be on the protective cover and the mobile cart. In addition, the dashes on the bottom of protective cart cover illustrates locations of glass beads or weights to help close protective cover and attach the protective cover to the mobile cart.

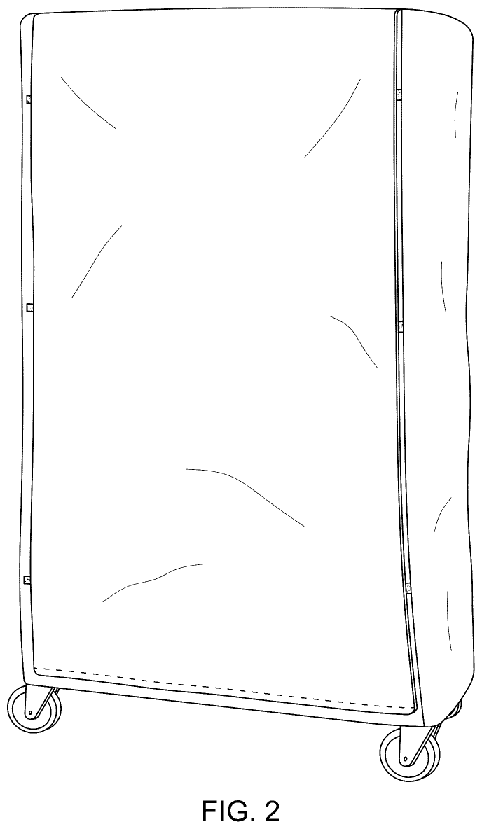

FIG. 3 illustrates a mobile delivery cart currently with a mobile delivery cart cover lifted up somewhat to show the shelving inside.

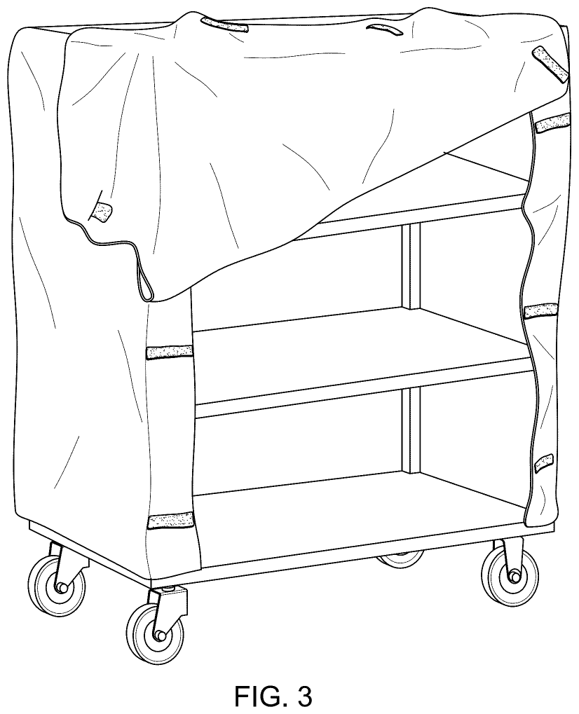

### DETAILED DESCRIPTION OF THE INVENTION

A protective cover assembly primarily designed to enclose a mobile delivery cart of the type used for the distribution of a variety of items, at least some of which should be maintained in at least a partially sterile environment, such as items used in hospitals or like medical facilities. The protective cover assembly includes magnets along both outside edges of the protective cover which not only weigh the cover down, but are also magnetically attracted to magnets located on the outside edges of the cart, facing the cover, thereby connecting the cover assembly to the mobile delivery cart. In this manner any number of items may be periodically removed from the mobile delivery cart while preserving the partially to mostly sterile environment on the mobile delivery cart. If the mobile delivery cart is metal, the magnets on the protective cover assembly may be all that is needed to facilitate connection of the protective cover assembly and the outside edge of the cart. If the mobile delivery cart is not metal, magnets or at least pieces of metal, must be attached to the mobile delivery cart's outside edge that is facing the protective cover assembly, to connect the protective cover assembly to the mobile delivery cart.

1. A protective cover assembly of a mobile delivery cart, wherein the outside edges of said cover assembly have magnets attached therewith and those edges, of said mobile delivery cart facing said cover assembly's outside edges, are made of metal such that a magnetic force pulls together said protective cover assembly and said mobile delivery cart.

2. The mobile delivery cart of claim 1, wherein said mobile delivery cart is not made of metal.

3. The mobile delivery cart of claim 2, wherein when said mobile delivery cart is not made of metal, magnets, or some kind of metal, must be attached to said mobile delivery cart's edges that are facing said protective cover assembly.

4. The protective cover assembly of claim 1, wherein along the bottom of said protective cart cover, glass beads or something heavy can be attached to weigh said protective cover down and assist in closing the protective cover.
